(19) United States
(12) Patent Application Publication
(10) Pub. No.: US 2005/0145691 A1
(43) Pub. Date: Jul. 7, 2005

(54) Reprove prepaid credit card

(76) Inventor: Regina Frances Dillard, Laurel, MD (US)

Correspondence Address: REGINA HARRIS, 15420 dacosta, Detroit, MI, 48223, US

(21) Appl. No.: 10/751,726

(22) Filed: Jan. 5, 2004

(51) Int. Cl. G06K 5/00

(52) U.S. Cl. 235/380

(57) ABSTRACT

The Prepaid Card uses an Electronic System (Process Server) for Issuance, activation, tracking activity and Balances; networking allowing the card user to purchase a card thru a bank, retail establishment, or other agencies, select an increment and card is automatically activated and can be used for immediate purchase. Use the card to purchase a wide range of good and services, and replenish for future use; to prevent fraud or illegal use, photo or fingerprint can be programmed into card.

### FIELD OF INVENTION

This invention relates to prepaid cards used to purchase goods or services, also making electronic payment easy, simple, and hassle free.

### DESCRIPTION OF INVENTION

God has given me the idea for the Reprove Card. It is a prepaid card that requires no back account. No credit check, and no waiting period to receive. You will be able to walk into your local retailer/merchant or bank and purchase the card with whatever amount of monetary increments you would like to spend and the card will be useful anywhere you chose to use it. Credit cards are not just for the elite. They are not only use for the prestige. Cash cannot be used in every situation. This allows you to have privileges of a credit card without the red tape of obtaining a credit card. It can allow you to live the American dream.

This is product has already proven to be very much a necessity and will be in great demand. I have traveled the United States and from Maine to California and any friend or family member that I have confided in has told me what a wonderful product it would be to have available to them, and that they would like to be the first on to purchase the card. So, the need has already been shown to be a proven fact.

Monetary documentation such a credit cards and debit cards do not provide any degree of anonymity since they require that the user wishing to purchase an item have a named account associated with the card. While these cards are not attached to a bank account, which eliminates the threat of all funds being depleted from your checking or saving account. This prepaid card allow you the spending privilege of purchasing products, without the dilemma of being without income if stolen, like you would be if it were stolen.

Credit card allow purchases or accounts receivable up to a specified credit limit based on an individual account relationship and determination of individual creditworthiness. Like credit cards, debit cards are limed to a specific amount if an individual at the financial institution, but transfer funds from the owner's account to the merchants account. An authorization routine is typically employed where the financial institution is contacted during the purchase to verify that the account is valid and that it has sufficient funds to make purchase.

Another type of card is the prepaid or secured credit card. This limited value card where a named user is historically a poor credit risk and therefore must pre-pay some amount of money to a financial institution. This security money is used to safeguard the financial institution is case the user does not pay for the name of the instruction or items. This is not technically not a debit card, the prepaid amounts function as a guaranteed by the purchaser an can be drawn against the event the funds advanced under the credit card account is not paid

As you can see, the financial instruments mentioned have their limitations that make them unsuitable for us in certain situations. Such as, when children leave home to go to college or live in residential housing. Expenses are incurred while away from home at school away form the watchful eyes of the parents. Children might be trusted with some type of credit card or debt card in the name of the parents to make purchases. But, some how do not watch their spending can create high outlays or expenses that the parents are or be responsible to pay. Possibly the student has or have not had credit in their own name and the requested credit card is denied to the student. A parent or someone else establishes a preferred person's account for them while in school. Any purchase made on this type of account can be registered under the credit worth person's name and social security number. This can cause the credit rating of the credit worthy person to become unsatisfactory. Or the student might not be able to understand the responsibility of a credit rating account and over spends and does not pay the debt owing and can become an unsatisfactory credit risk. Either way one or both parties credit can become unsatisfactory which can hurt their identity in the credit world.

When a person wants to rent a car they must have some type of evidence that they are who they say that they are before the car rental company will rent them a vehicle. The car rental company is counting on the premise that the credit card company has made a thorough investigation of the application that the person requesting credit from their company has signed and given to them. The car rental company or any other vendor or merchant is depending on the information on the application to locate the credit card holder when payment is not received. They are confident in some way that through the credit reporting agencies that they will be able to contact the credit cardholder and demand payment for Purchase(s).

Even in a perfect world sometimes credit worthiness, becomes unsatisfactory, such a co-signing for a child or parent who doesn't pay the account, whether you knew about the delinquency of the account or not. The credit rating agencies will report the account as delinquent. And this will show up on the primary creditor credit report. This will destroy a credit rating for anyone. This is why the Reprove pre-paid credit card is needed. And the purchaser doesn't need to have a rating to use the card nor does the purchaser need a financial account to obtain a card. The right to obtain A Reprove Pre-paid credit card is given when the purchaser at the point of sales gives a monetary amount for the card they want to use. The card is identifiable but is not associated with a named user unless requested by cardholder and is ready for immediate use. The card has a residual amount on balance, after cash use until card reaches a zero balance. The user can go to a designated vendor or bank and re-establish an amount to the face value, which appears, on the card. Server storage system will track and record the balance and amount of purchase(s), which will allow the server system to keep of amount of balance on card.

Also the tracking system will have a database as to the identification of each card, and what vendor has the card. Once a card is created and sent out for distribution.

It is desired that the Reproved Pre-Paid Credit Card, be accepted by merchants that already accept some type of credit card.

### BRIEF SUMMARY OF THE INVENTION

The Reprove Prepaid Credit Card is a prepaid credit card that will be used to purchase goods and services without the hassle and red tape that is associated with the traditional credit card. The Reprove Prepaid Credit Card is for those individuals who desires the benefit of a credit card but are unable to obtain a traditional credit card. Some individuals are unable to obtain a credit card due to credit worthiness, and some simply do not wish to pay the interest associated with a credit card.

The Reprove Prepaid Credit card is similar to a prepaid phone card, and can be completely anonymous. Reprove doesn't have to be attached to a bank account, which eliminates the risk of fraud to your personal accounts. It can be used for travel, hotel reservations, rentals and everyday purchases. The Reprove Prepaid credit card can be purchased from any vendor, bank or retail store in increments beginning at $50.00.

### BRIEF DESCRIPTION OF FIGS

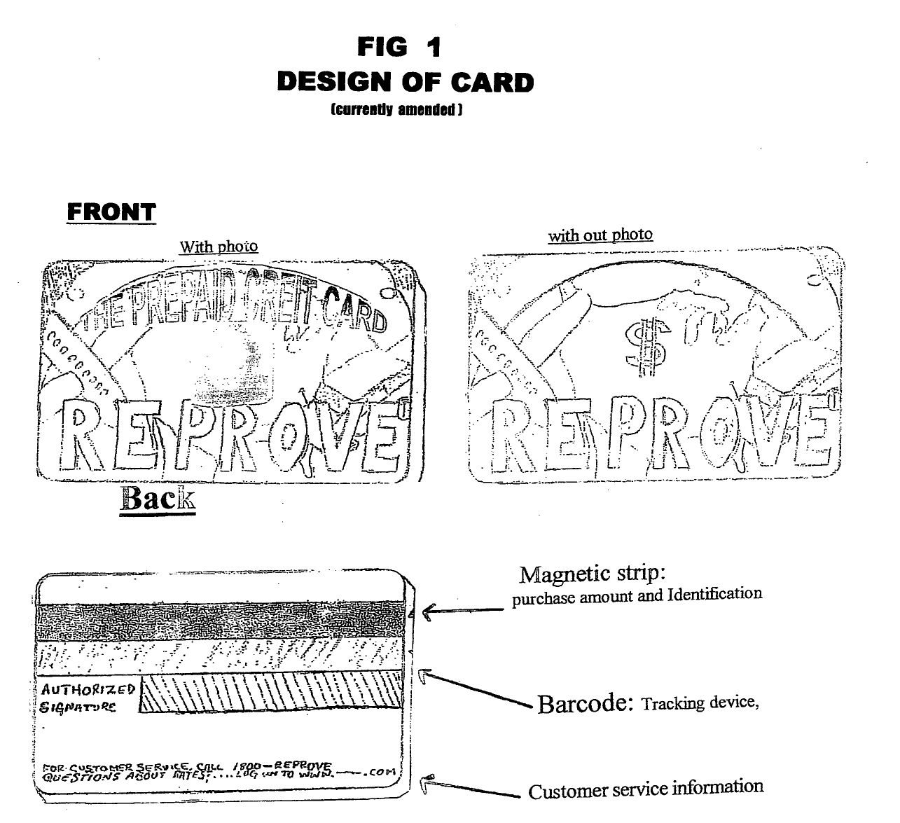

FIG. 1

Is the suggested design of card 006. The front of card has photo and or finger print. Programmed into card for added security. Or card 006 will have the value of card on front.

On the back of card 006, will have a magnetic strip which will hold the purchasers account and identification information. It will also have a bar code which is a tracking device, it will also have information to contact customer service incase of any problems or emergencies.

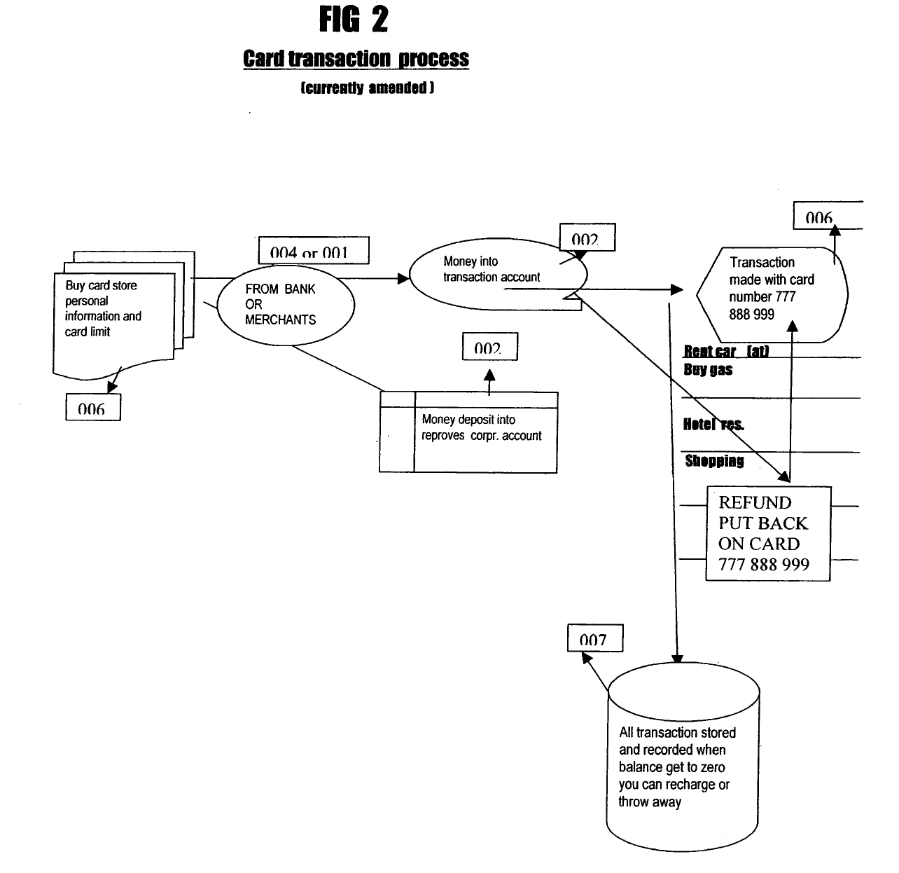

FIG. 2

Is the card transaction card 006, from a merchant 004 or bank 001 information is stored on a card 006 and activation process you pay for a card 006, value of card is stored on card 006. The value of the activated card is then direct to Reprove transaction system 007, as transactions are made.

If at any point when using card a refund has to be made or is required the card 006, can be swiped at place of purchase and amount of refund will be restored back on to card 006. When balance gets to zero you can replenish you card or throw it away.

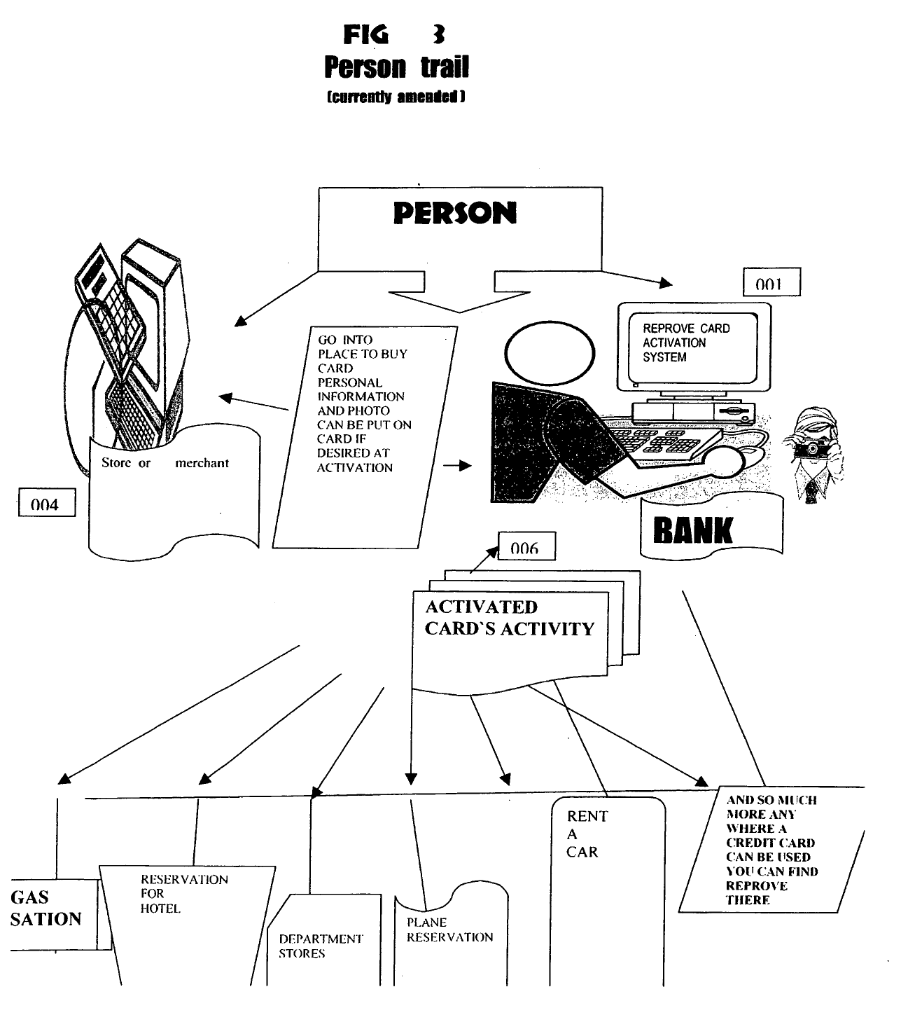

FIG. 3

This is the person trail. A person purchases card from merchant 004, or bank 001, information is stored on card at time of purchase, photo or fingerprint can be stored on card 006 at bank 001. Activated card is then directed to Reprove transaction account as transactions are made.

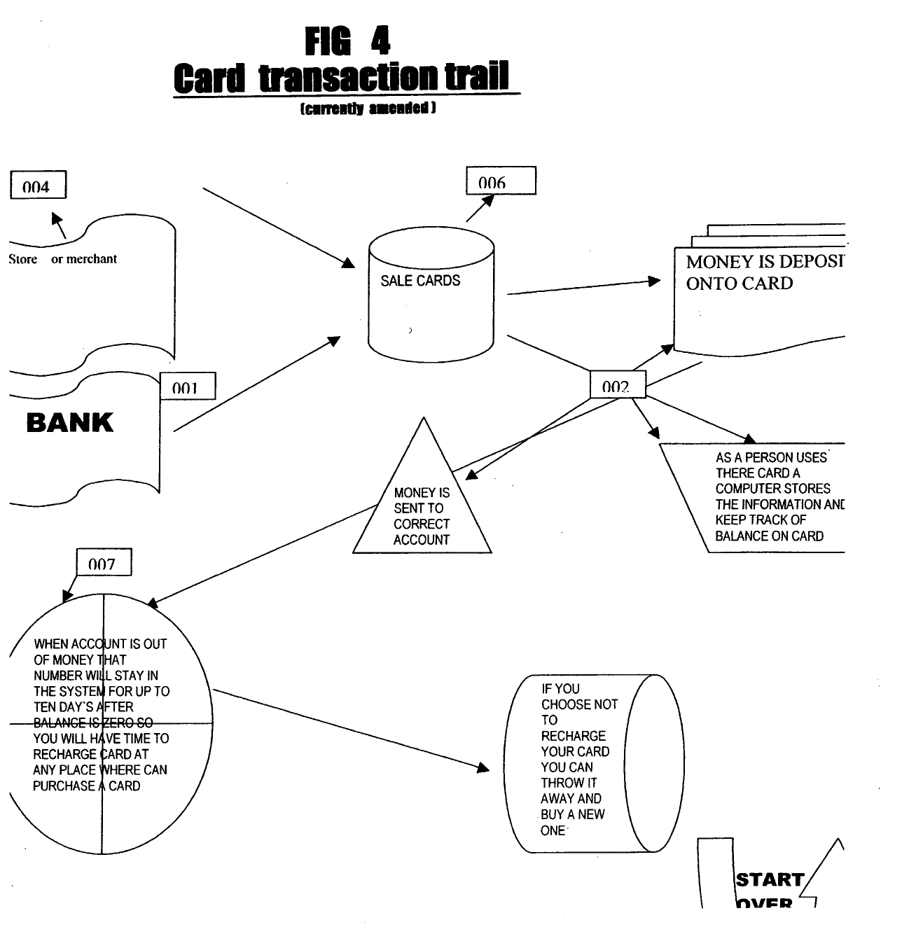

FIG. 4

This is card transaction trail. You can go into a bank 001 or purchase card from merchant 004, which can be used to make transactions. As the purchaser uses their card 006 the computer stores 007 & 002 the balance. When balance reaches zero you can throw card away or replenish card and start process over again.

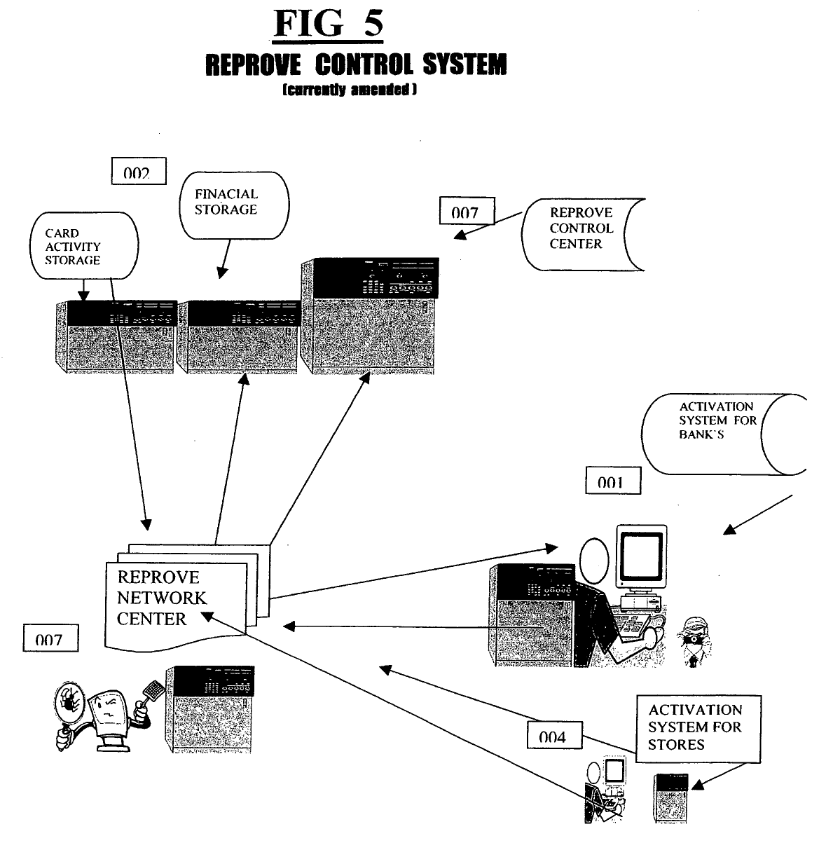

FIG. 5

Reprove Control System. The Reprove company is a control center 002, it will store the information a financial part of the card and the tracking part into control center 007. The card is place into an activation system on site at bank 001 or at merchant 004, which will then pull information from Reprove control center 002 & 007. Tracking card balance and transaction.

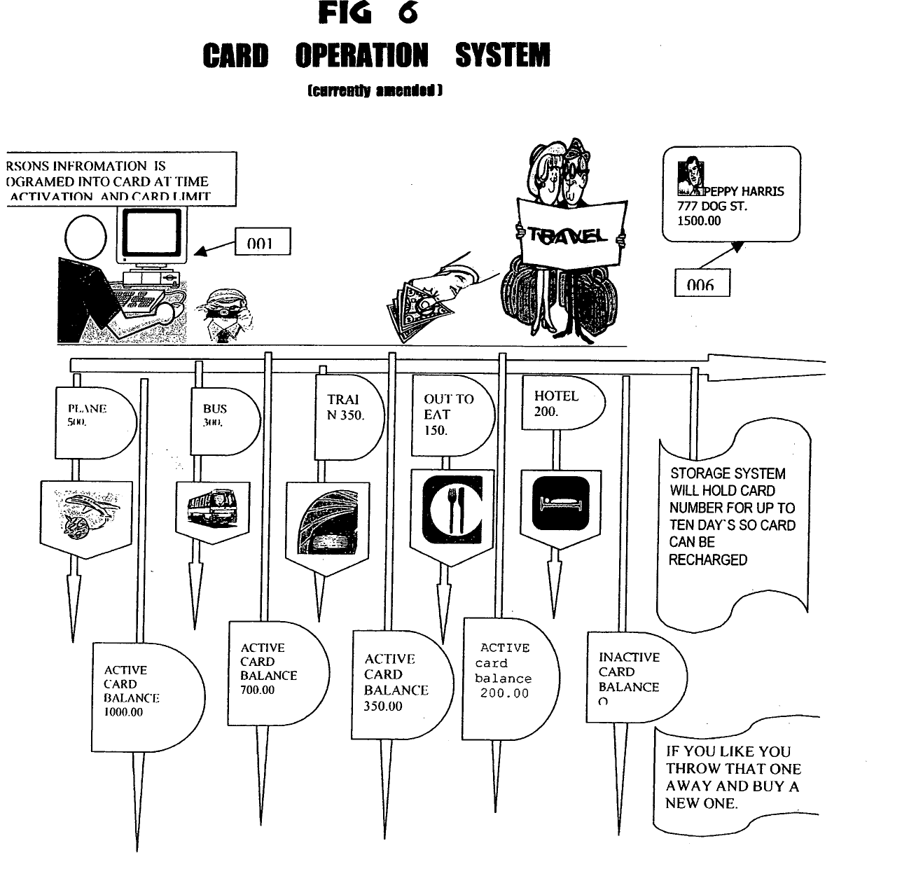

FIG. 6

Reprove Operation System. A person purchases a card 006. The card is placed into activation system on site at bank 001, can have their photo 005 and or figure print programmed on card. The card 006 can be used to make purchases the storage system will hold a card number for up to 10 days after card 006 has reach zero, to give time to replenish card 006, or you can dispose of card.

### DETAILED DESCRIPTION OF INVENTION

The Reprove Prepaid card is similar to a prepaid phone card, and can be completely anonymous. However, can be purchased with a photo and fingerprint, which is programmed into card when purchased from the bank, which provides added security. No personal identification is required at the vendor, bank, or retailer to purchase the Reprove Prepaid Credit Card. The Reprove Credit Card is not attached to a bank account, which eliminates the risk of fraud to your personal accounts. It can be used for travel, hotel reservations, rentals and everyday purchases. The Reprove Prepaid Credit Card can be purchased from any vendor, bank or retail store in increments beginning at $50.00.

1. A process of obtaining or purchasing a Reprove Prepaid Credit card involving:
A Bank, vendor, or retailer for the disbursement of the Prepaid Credit Card; A purchaser for buying the Prepaid Card at the interval needed, Activating the Prepaid Credit Card after the card is purchased; and utilizing the card for transactions similar to traditional Credit Cards

2. The Method of claim 1, wherein allowing purchases in intervals of $25 or more.

3. The Method of claim 1, wherein Purchases can include Hotel Reservations, Plane Tickets, Car Rental, or any purchases which utilize Currency or Traditional Credit Cards.

4. A system Containing;
Means for allowing a credit cardholder to remain anonymous or have photo and or fingerprints inputted for identification purposes; and means for purchasing a card without being conformed to traditional credit card approval.
